(19) United States
(12) Patent Application Publication
(10) Pub. No.: US 2002/0187791 A1
(43) Pub. Date: Dec. 12, 2002

(54) Security system and security apparatus

(75) Inventors: Masutomi Ohta, Yokohama (JP); Hiroyasu Ohtsubo, Yokohama (JP); Takayuki Kawahara, Higashiyamato (JP); Kei Suzuki, Kokubunji (JP); Koji Sakamoto, Hachioji (JP); Hiroshi Hatae, Toda (JP); Yasuhiro Hirano, Hachioji (JP)

Correspondence Address: McDermott, Will & Emery, 600, 13th Street, N.W., Washington, DC, 20005-3096, US

(73) Assignee: HITACHI, LTD.

(21) Appl. No.: 09/935,667

(22) Filed: Aug. 24, 2001

(30) Foreign Application Priority Data
Jun. 11, 2001 (JP) 2001-174975

(51) Int. Cl. H04Q 7/20

(52) U.S. Cl. 455/456; 455/556

(57) ABSTRACT

It is an object of the present invention to provide a security system and security apparatus with excellent user-friendliness. A receiver 5 acquires the phone number of a cellular phone carried by a visitor, the transfer function unit 204 checks the phone number thus acquired against the phone number of an anticipated visitor to identify the visitor, and transfers the information to a personal digital assistant (PDA) unit to be redirected if the transfer is judged to be necessary.

### BACKGROUND OF THE INVENTION

This invention in general relates to a security system, security/apparatus, security system with the closed circuit camera, and intercom which are used to respond to visitors, and more particularly to a door intercom with improved convenience that allows an occupier of a dwelling, in case a visitor is available while the occupier is away, to deal with such visitors, by enabling communication between a personal digital assistant (hereinafter referred to as PDA) unit used at a remote place and the door intercom.

The security apparatus installed outside the front door is a device to respond from within the dwelling to visitors. Conventionally, only audio information from visitors could be delivered indoors, but recently, it has been possible to monitor images of visitors in the room due to reduced prices of imaging devices.

On the other hand, the progress in technologies of PDA units has made it possible to transmit and receive not only a static image but also a moving image.

Consequently, in order to promote the convenience of users also in the field of security apparatus, Japanese Patent Laid-open No. 11-136376 describes to the transfer of image information of a visitor, who visits a dwelling while the occupier is away, to a PDA unit carried by the occupier at a remote place.

### SUMMARY OF THE INVENTION

However, since the system described in Japanese Patent Laid-open No. 11-136376 does not have a function to identify only visitors to whom the occupier should really respond, it had a disadvantage to unlimitedly transfer the information of visitors including door-to-door salesmen that are not necessary to be transferred.

To identify such necessary visitors, means which utilize personnel information reflecting physical characters including vocal patterns, fingerprints, looks, and irises could be one solution. However, the means present a problem in that the accuracy to determine them is not technically satisfactory, and in addition, each individual cannot be identified in case where a visitor is unspecified and visit the dwelling for the first time.

Japanese Patent Laid-open No. 11-187389 also describes a system which will automatically unlock the door and initiate a call bell by reading an ID plate carried by a visitor. However such plates should be distributed to all anticipated visitors in advance, which will consequently cause a problem that each individual cannot be identified if visitors are unspecified and visit the dwelling for the first time.

Another means may also be considered whereby authentication code information such as IDs and passwords that have been agreed in advance will be stored in the security apparatus, and based on such information, visitors will be identified depending on the authentication code information thus entered, even if the visitors make their first visit to the dwelling. However, in this case, since the combination of code information can be achieved rather easily, there was a risk of having “pretending” visitors who acquired the information unlawfully.

In view of the foregoing problems, it is an object of this invention to provide a security system and security apparatus which allows to enhance the degree of accuracy in identifying visitors and to enable visitors who may visit a dwelling for the first time to communicate with the occupier who is away from the dwelling.

In order to achieve the foregoing object, the security apparatus of the present invention has adopted the configuration wherein, to identify a visitor, individuals are first identified based on the phone number of cellular phone carried by the visitor, and based on the identification result, information is transferred to the PDA unit carried by the occupier who are away from the dwelling.

Since the identification of each individual is performed based on the cellular phone number, it is possible to avoid erroneous judgments as may be experienced in the identification of individuals according to physical characters including vocal patterns, finger prints, looks, and irises, thus enabling correct identification of each individual.

In addition, the use of cellular phone carried by visitors contributes to save labor such as the distribution of ID plates in advance, and if the phone number could be identified, the apparatus is able to deal with even first-time visitors.

Furthermore, it has been so configured that the security apparatus transmits the read-out cellular phone number carried by a visitor to the server placed in security company via a network, the security company identifies the visitor and determines if the transmission should be made. If the security company has acknowledged telephone numbers, for example, of express courier service companies, it is possible, based on such data, to make a decision whether to transmit in accordance with the occupation of the visitor, and if the security company can acquire the delivery schedule in advance, it is also possible to judge if the visitor is qualified. Consequently, the degree of accuracy in identifying individuals will be improved, and it becomes possible to deal with visitors even if they visit the dwelling for the first time or they are unspecified.

### BRIEF DESCRIPTION OF THE DRAWING

These and other features, objects and advantages of the present invention will become more apparent from the following description when taken in conjunction with the accompanying drawings wherein:

FIG. 1 shows a block diagram for a first and a second preferred embodiment in accordance with the present invention;

FIG. 2 shows an example of receiving characteristics of a receiver;

FIG. 3 shows a block diagram for a third embodiment in accordance with the present invention;

FIG. 4 shows a block diagram for a fourth embodiment in accordance with the present invention;

FIG. 5 shows a block diagram for a fifth embodiment in accordance with the present invention;

FIG. 6 shows a block diagram for a sixth embodiment in accordance with the present invention; and

FIG. 7 shows a block diagram for a seventh embodiment in accordance with the present invention;

### DETAILED DESCRIPTION OF THE EMBODIMENTS

Preferred embodiments of the present invention will be described hereunder.

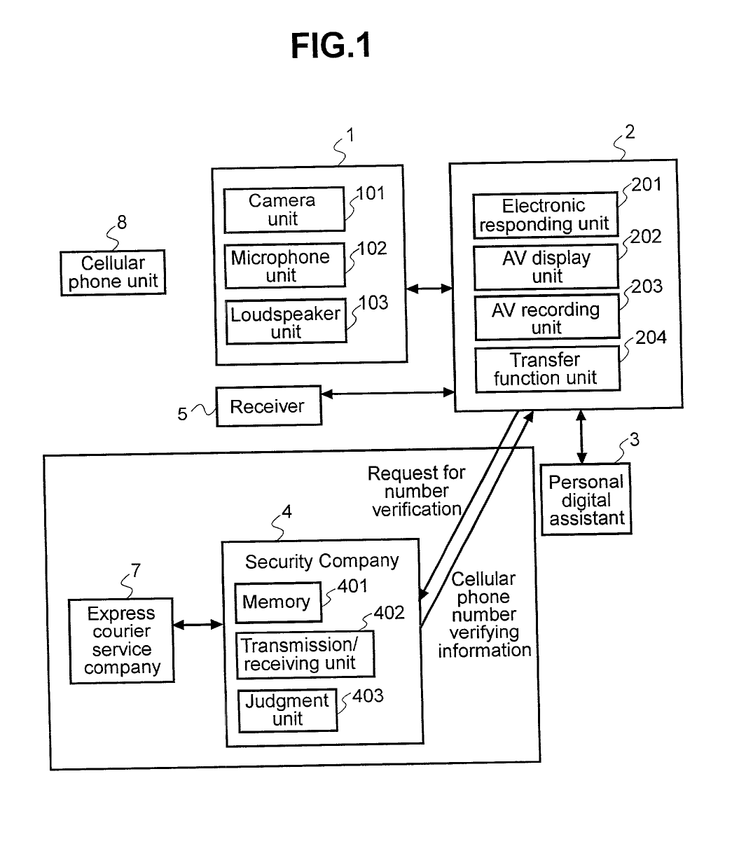

FIG. 1 shows a first embodiment in accordance with the present invention. The first embodiment identifies each individual by utilizing the phone number of cellular phone transmitted to base stations. Cellular phones, even while they are not operated, continuously transmit and receive information regarding respective positional relationship every one to five seconds to and from base stations. Cellular phones also transmit their own phone number during such communication. With the present embodiment, the identification of a visitor is realized by receiving such cellular phone numbers. More specifically, the embodiment allows the identification of cellular phone numbers carried by visitors, check of the personal information of anticipated visitors that are stored in the security apparatus against the phone number information, and the execution of information relaying to the PDA unit carried by the occupier who are away from the dwelling.

The security apparatus comprises an outdoor unit 1 of security apparatus, an indoor unit 2 and a receiver 5 which receives a cellular phone number. A camera unit 101 takes a picture for a visitor and produces video signals thereof. A microphone unit 102 collects a voice of a visitor and produces audio signals. A loudspeaker unit outputs voices to visitors. The video and audio signals supplied by the camera unit 101 and the microphone unit 102 are displayed and output by an AV display unit 202, and an AV recording unit 202 records video and audio signals supplied by the camera unit 101 and the microphone unit 102 respectively. An electronic responding unit 201, in response to operations of the outdoor unit by a visitor and a voice generated by the visitor, generates audio signals to be supplied to the loudspeaker unit. A transfer function unit 204 determines, based on the cellular phone number received by the receiver, whether or not to execute the transfer to a PDA unit 3 to be redirected. More specifically, the transfer function unit 204 comprise a memory which stores telephone numbers, for example, of anticipated visitors, a memory which stores cellular phone numbers of anticipated visitors in advance, transfer-judging means which compares the phone number of a visitor with the phone number stored in the memory to determine whether or not to execute the transfer to the PDA unit 3 to be redirected, and means which, based on the result of judgment by the transfer-judging means, notifies the PDA unit 3 to be redirected of one's visit. A receiver 5 is acquisition means to acquire the cellular phone number of visitors, and it receives communication signals from base stations that are transmitted every one to five seconds by a cellular phone unit 8 carried by a visitor.

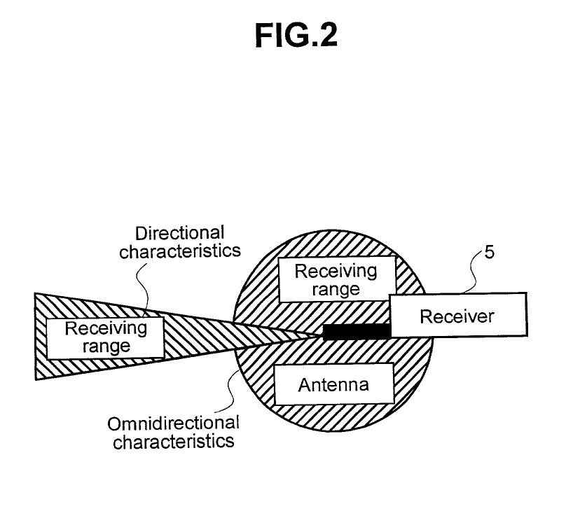

The receiver 5 will be realized by giving the receiving characteristics as shown in FIG. 2. One characteristic covers the range which allows the reception of signals only from the front side of the outdoor unit 1 by giving a directivity to the antenna of the receiver 5. The other characteristic covers the range which allows the reception of signals available only within a certain distance (e.g. 1 m to 2 m) from the outdoor unit 1. By making such receiving characteristics available, the receiver 5 can receive only signals from the cellular phone 8 carried by visitors. It should be noted, however, the omnidirectional characteristic is preferred to give higher practicability since it allows to pick up signals available in all surrounding directions of the receiver.

In addition, since such components incorporated in the security apparatus as the camera unit 101, microphone unit 102, and loudspeaker unit 103 of the outdoor unit 1, and the AV display unit 202 and AV recording unit 203 of the indoor unit 2 are included in a conventional type of security apparatus with a TV camera, the security apparatus in accordance with the embodiment may be realized by adding a receiver and a transfer function unit to the conventional apparatus.

The operation will be described hereunder. The occupier of a dwelling stores cellular phone numbers of anticipated visitors, acquaintances, relatives and so forth in advance in the memory device which is the memory of the transfer function unit 204.

When a visitor operates a device including a call bell which is not illustrated in the figure but located outside the dwelling to initiate the outdoor unit 1 of the security apparatus, the electronic responding unit 201 of indoor unit 2 outputs specified message signals (voice messages such as “Who is it?” and “What can I do for you?” in the case of the present embodiment). While the visitor is responding to such messages (one to five seconds), the receiver 5 reads the phone number from the communication signals available between the cellular phone 8 carried by the visitor and the base stations, and sends the information to the transfer function unit 204 of the indoor unit 2.

The transfer function unit 204 checks the phone number of cellular phone unit 8 that has been received by the receiver 5 against phone numbers of anticipated visitors, acquaintances, relatives and so forth stored in advance in the transfer function unit 204 to identify the visitor. Then, if the transfer function unit 204 finds a corresponding phone number in the record, it notifies the PDA unit 3 to enable communication with the visitor. Besides the communication in voices, it may be possible to first give a notice of having a visitor, and then transmit an image taken by the camera unit.

According to the embodiment, the identification of individuals can be achieved with a high degree of accuracy since it is made based on cellular phone numbers. In addition, the use of cellular phone numbers enables the identification of individuals even if they are first-time visitors, which contributes to the realization of a highly-convenient security apparatus.

Next, a second embodiment is described wherein cellular phone numbers received are transmitted to a security company, and the security company identifies individuals. In the embodiment, the section surrounded with dotted lines on FIG. 1 is added to FIG. 1 which is referred to in the description of the first embodiment, and items already described regarding FIG. 1 are omitted here.

FIG. 1 shows a security system according to the second embodiment. The security system comprises a security apparatus and a server 4 owned by a security company. The security apparatus includes an outdoor unit 1 and an indoor unit 2 of a security apparatus and a receiver 5 which receives cellular phone numbers. The server 4 owned by a security company comprises a memory device 401 which stores phone numbers of anticipated visitors including, for example, cellular phone numbers of staff from courier service companies, a transmission/receiving unit 402 which receives phone numbers of visitors transmitted by the indoor unit of the security apparatus, and a judgment unit 402 which is transfer judgment means that compares phone numbers stored in the memory device 401 with those actually received to determine, based on the comparison result, whether or not to execute the transfer to the PDA unit 3 to which the information should be transferred.

A user will apply the security company for the service. The security company exchanges the information with the express courier service company 7 in accordance with the address information of the user who applied for the service, and stores the cellular phone numbers of deliverymen who belong to the express courier service company and are in charge of the residential area of the user, in the memory device 401.

When a visitor operates a device including a call bell, which is not illustrated in the figure but located outside the dwelling, to initiate the outdoor unit 1 of the security apparatus, the electronic responding unit 201 of indoor unit 2 outputs specified message signals (voice messages such as “Who is it?” and “What can I do for you?” in the case of the present embodiment). While the visitor is responding to such messages (one to five seconds), the receiver 5 reads the phone number from the communication signals between the cellular phone 8 carried by the visitor and base stations, and sends the information to the transfer function unit 204 of the indoor unit 2.

The transfer function unit 204 first attempts to check the phone number of cellular phone unit 8 that has been received by the receiver 5 against phone numbers of anticipated visitors, acquaintances, relatives and so forth stored in advance in the transfer function unit 204 to identify the visitor. Then, if the transfer function unit 204 does not find a corresponding phone number in the record, it transmits the phone number of cellular phone unit 8 to the transmission/receiving unit 402 of the server 4 located in the security company.

The judgment unit 403 of server 4 located in the security company checks the phone number of cellular phone unit 8 thus received against the contents of memory device 401, and identifies the owner of the corresponding phone number. Then, the result judged by the judgment unit 403 is transmitted by the transmission/receiving unit 402 back to the transfer function unit 204 of the indoor unit 2 as the information to verity the cellular phone number. If the person who was already identified by the server 4 located in the security company are verified to be a qualified visitor to whom the information can be transferred (in this case, those persons including the deliverymen from the express courier service company), the information to indicate the conformance is transmitted the transfer function unit 204 by the transmission/receiving unit 402. The transfer function unit 204 notifies the PDA unit 3 of the information, to enable the communication with the visitor or to transmit an image taken by the camera unit.

In the present embodiment, in addition to the effect described in the first embodiment, it is possible to easily identify servicing companies which could be categorized as unspecified visitors who cannot be identified in the category of individuals.

The second embodiment as described above was so configured that the transfer function unit 204 stores cellular phone numbers of persons including anticipated visitors, acquaintances, relatives and neighbors in advance, and judgment is made first to check whether the cellular phone number received by the receiver has been stored in the transfer function unit or not, but it may also be possible to adopt the configuration wherein all phone numbers, without providing a memory in the transfer function unit, are stored in the memory device 401 located in the security company, and all phone numbers received from visitors are transmitted to the server in the security company so that judgment is made by the judgment unit of the security company. The configuration wherein information including phone numbers of acquaintances of the occupier are stored in the transfer function unit 204 is advantageous if the disclosure of those information to the security company is not desirable, but it offers an advantage that the configuration of the security apparatus to be installed in the dwelling can be simplified if the overall administration can be entrusted to the security company.

Although a description has been made in the above to the configuration wherein the transfer function unit 204 transmits only phone numbers, it may also be possible to adopt another configuration wherein images taken by the camera unit 101 and voices collected by the microphone unit are transmitted along with phone numbers to the server of the security company for the judgment whether or not to execute the transfer, while secondarily utilizing such images and voices together with the verification result of phone numbers by the server of security company. In this case, the transmission of such image and audio signals to the PDA unit may be substituted with the transfer which is executed to the PDA unit 3 not by the transfer function unit but by the judgment unit 403 and the transmission/receiving unit 402 of the server 4 located in the security company.

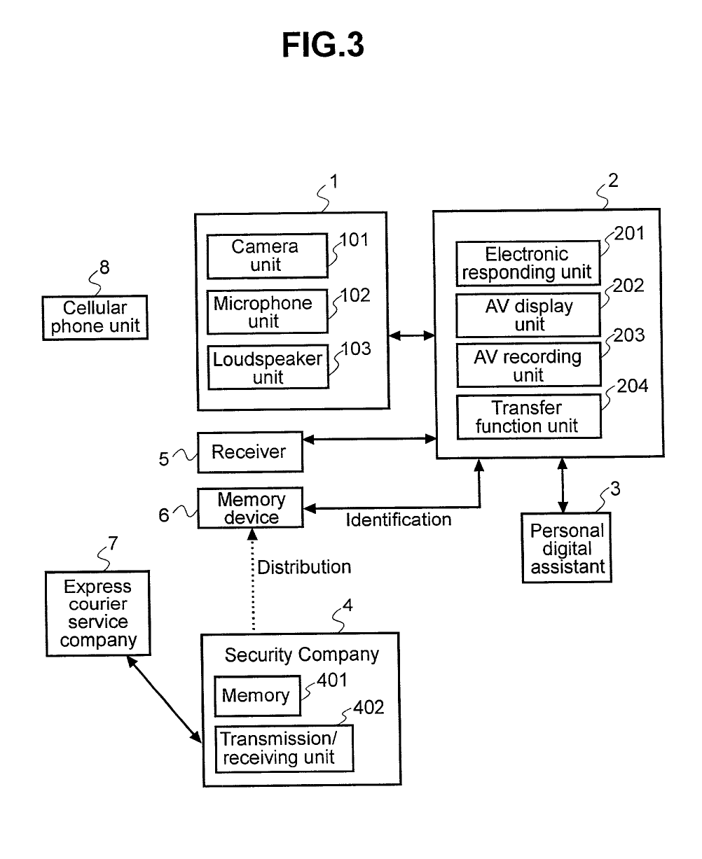

In the following, a third embodiment of the present invention will be described with reference to the drawing of FIG. 3, wherein the relaying of information is made to the PDA unit of the occupier who is away from the dwelling by checking the phone number information of cellular phone carried by a visitor against the visit-schedule information that is periodically transmitted in advance by the security company regarding a deliveryman from the express courier service company.

The basic configuration comprises an outdoor unit 1, an indoor unit 2, a PDA unit 3, a server 4 located in a security company, a receiver 5, and a memory device 6. Since units and devices that are given the same number as in FIG. 1 have the same functions as those shown in FIG. 1, their descriptions are omitted.

First of all, a user will apply the security company for the service. The security company exchanges the information with the express courier service company 7 in accordance with the address information of the user who applied for the service, and selects the necessary cellular phone number information only, taking the schedule of a deliveryman who belong to the express courier service company and are in charge of the residential area of the user into consideration, and periodically distributes the information to the memory device 6 of the user.

Likewise the first embodiment, the receiver 5 detects the phone number information of cellular phone unit 8 of a visitor within a certain period of time (one to five seconds) after the visitor has operated the outdoor unit 1.

The transfer function unit 204 takes the information such as the phone number of the cellular phone unit 8 of the visitor and the time zone of the scheduled visit for making the judgment, calls the PDA unit 3 located at a remote place if the person who is identified through the check with the delivery schedule information in the memory device 6 corresponds to the qualified visitor, for example a deliveryman from the express courier service company, to whom the information should be transferred, and enables the communication with the visitor or the display of an image on the PDA unit 3. Furthermore, the transfer function unit 204 records information including the phone number of the PDA unit 3 located at a remote place to which the information is relayed.

In view of the foregoing description, with the method adopted in the present embodiment, personal information on anticipated visitors, for example, of schedule information including visiting areas and times as well as the phone number of cellular phone owned by visitors that are provided by an information service company such as a security company are acquired from a channel different from that for the ID information owned by the visitor, which enables the prevention of so-called “pretending” visitors as well as the highly accurate identification of visitors.

Furthermore, with the present embodiment, a description are made on an example of relaying information to the occupier who is away from the dwelling, but it is obvious that the embodiment is applicable to the limited use of identifying visitors even in a case where the occupier stays at home. For example, in such a case where a deliveryman, after having quitted an express courier service company, tries to break into a dwelling, pretending to be a deliveryman of a parcel service, it was difficult for conventional methods to prevent such problem, but the present embodiment can prevent the problem before it happens.

In the first through the third embodiments stated above, a description was made to an example in which the cellular phone number is acquired by receiving the phone number information periodically transmitted by the cellular phone to base stations. For an alternative method to acquire the cellular phone number, it may also be possible to adopt a configuration wherein the cellular phone unit is provided with a function to transmit the cellular phone number through communication means including Bluetooth, and the receiver 5 receives the cellular phone number which is transmitted upon the operation of a visitor.

In the following, functions to improve the user-friendliness will be described.

As the primary function, a function which makes the PDA unit 3 carried by the occupier away from the dwelling execute setting and changes of transfer-relaying conditions can be pointed out. The function to set and/or change transfer-relaying conditions can be realized by adding a mechanism to set transfer conditions to the transfer function unit 204 of the outdoor unit 2, and deciphering and recording the transfer conditions transmitted by the PDA unit 3 located at a remote place. In other words, the transfer conditions setting mechanism deciphers the transfer conditions by means of a speech recognition processing if the information is supplied in audio signals, or by a code identification processing if they are supplied in pre-specified codes and so forth. The mechanism then returns the deciphered contents back to the PDA unit 3 located at a remote place for the confirmation processing, and records them as transfer conditions.

As the secondary function, a function which allows, at the PDA unit 3 located at a remote place, an easy discrimination of the reception of transfer relaying calls from normal communication calls can be pointed out. Regarding the discrimination function, it is possible to discriminate the transfer relaying calls from normal communication calls, for example, by adding and transferring information which presents specified melodies or screens for signal incoming calls at the transfer function unit 204 of indoor unit 2, and by presenting, based on such information, specified melodies or screens for signal transfer-relaying calls at the PDA unit 3 located at a remote place.

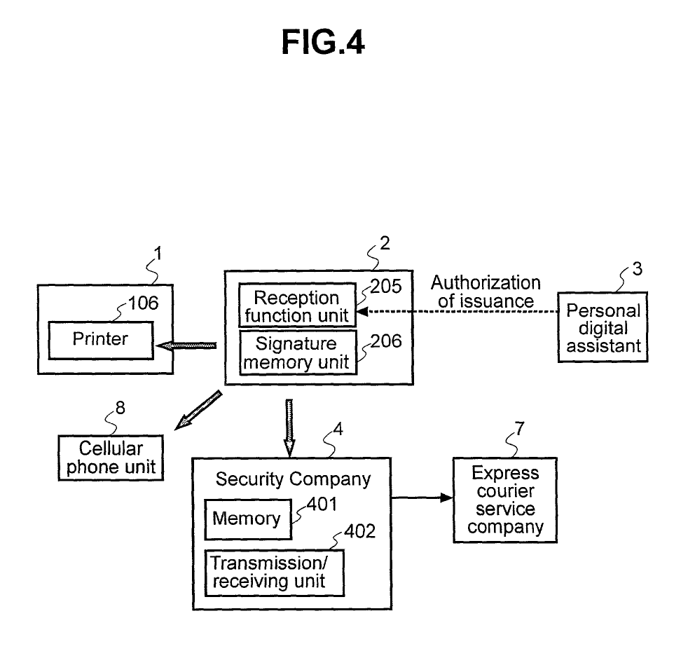

In the following, a fifth embodiment will be described with reference to the drawing of FIG. 4, wherein the reception signature for delivered package is transmitted by the PDA unit 3 located at a remote place. In the embodiment, the transfer relaying is executed to the PDA unit 3 located at a remote place after completing the identification of a visitor, and the signature for the reception of package delivered, for example, by a deliveryman of the express courier service company 7 is transmitted from the PDA unit 3.

The PDA unit 3 delivers a password, which has been authorized to be issued, to a reception function unit 205 of the indoor unit 2. The reception function unit 205 that has received the password reads out the signal for the reception signature accumulated and stored in a signature memory unit 206. Then, the reception function unit 205 issues, based on the signal, a reception signature of either of the following three means:

(1) The signal for the reception signature is transferred to a printer 106 of the outdoor unit 1, and a deliveryman receives the reception signature printed out by the printer 106.

(2) The signal for the reception signature is transferred to the cellular phone unit 8 carried by a deliveryman.

(3) The signal for the reception signature is transferred to the express courier service company 7 via the server 4 located in the security company.

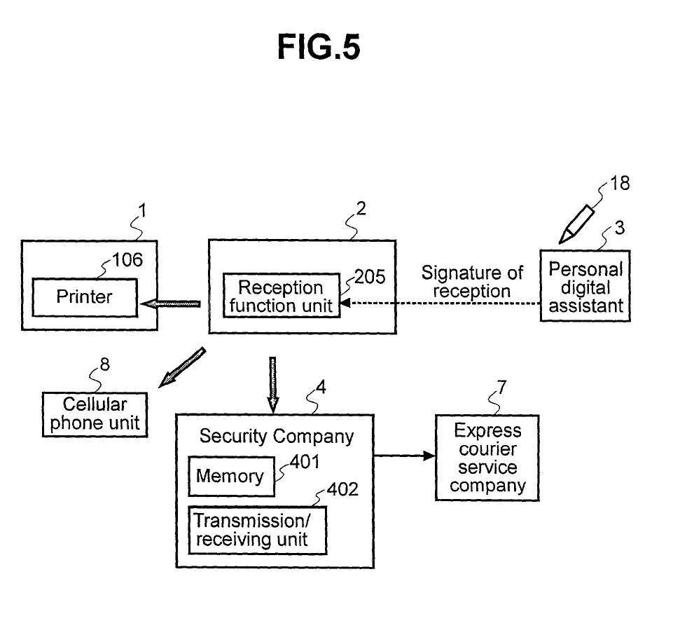

Next, a case will be described with reference to the drawing of FIG. 5, wherein a reception signature for the delivered package is written on the PDA unit 3 located at a remote place whenever it is required. With the embodiment, the system is realized by adding a pen-type input device 18 to the foregoing configuration.

The pen-type input device 18 is, for example, provided with a small optical sensor at the tip of the pen, reads the pen movement by detecting the reflection of a laser beam irradiated toward the tip, and execute the data transfer to the PDA unit 3 by using Bluetooth. The reception signature is written with the pen-type input device 18. The data of the reception signature transferred to the PDA unit 3 is then delivered to the reception function unit 205 of the indoor unit 2.

The reception function unit 205 sends the data of reception signature received to the printer 106 of the outdoor unit 1 for printouts, or transfers the data to cellular phone unit 8 carried by a deliveryman, or transfers the data to the system of the express courier service company 7 via the server 4 located in the security company.

As stated above, according to the present invention, it is possible to improve the level of user-friendliness far better than that attained by the prior art.

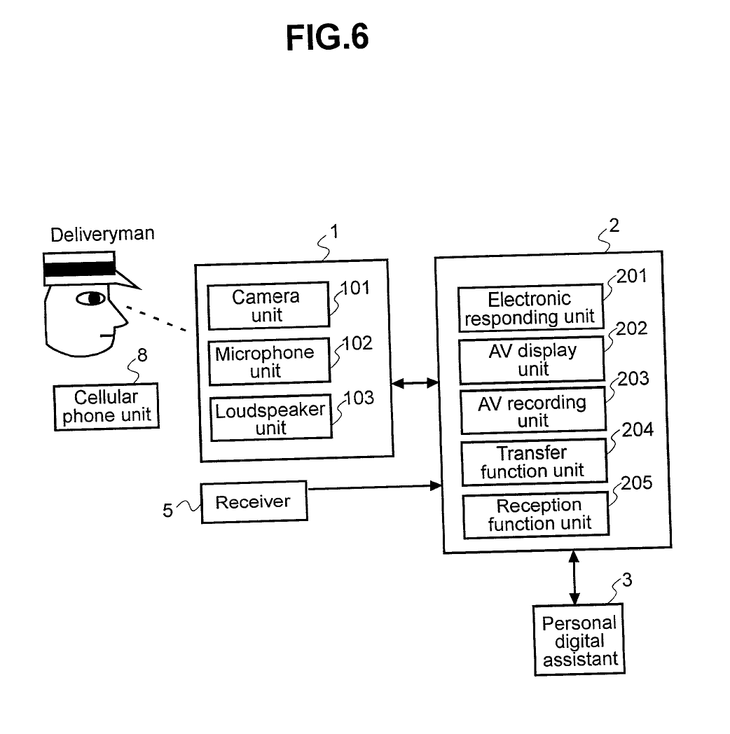

In the following, a sixth embodiment will be described with reference to FIG. 6, wherein the security level, at the time of issuing such reception signature, is enhanced by recording the image information on a visitor.

With the embodiment, since the package delivered while the occupier is absent is indirectly received at a place away from the dwelling, it may be possible that the availability of the package could be a source of problems when the occupier comes back to the dwelling. In order to eliminate such worry, it is necessary to keep the image information (such as looks and costume) on the deliveryman taken at the time of receiving the package as evidence.

Specifically, with the security apparatus of door intercom, the camera unit 101 takes an image for a visitor at the time when the visitor makes a call and displays the image on the AV display unit 202 of the indoor unit 2. The image of the visitor, for example, the deliveryman from an express courier service company, is stored in the AV recording unit 203 of the indoor unit 2 at the time when the reception function unit 205 has issued a reception signature. Since such arrangement enables to simultaneously keep the image of the deliveryman as well as the phone number of a cellular phone carried by the deliveryman as records, they will be beneficial in dealing with problems that may happen at a later date.

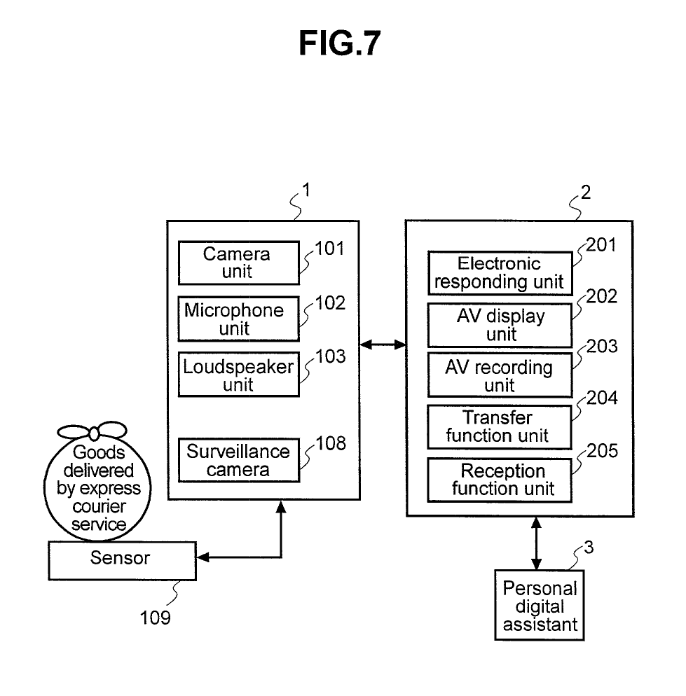

In the following, a function which monitors delivered packages after the reception of the package until the occupier comes back to the dwelling will be described with reference to FIG. 7.

Typically, a package delivered during the absence of the occupier is placed in the vicinity of the entrance door since it cannot be taken into the dwelling. The sensor 108 is a sensor to detect weight and is arranged at a position where the delivered package is placed. The sensor 108 is activated by the weight of package delivered and placed on it. Therefore, if a suspicious person has taken the package away, the weight varies to enable the detection of an unusual situation. A surveillance camera 109 monitors the area where the delivered package is placed. Motion pictures taken by the surveillance camera 109 before and after the sensor 108 detects an unusual situation are stored in the AV recording unit 203 of the indoor unit 2. In addition, one camera unit 101 of the outdoor unit 1 can serve the function of the surveillance camera 109, if the camera unit 101 is capable of simultaneously monitoring both the visitor and the area where the delivered package is to be placed.

As stated above, according to the present embodiment, it is possible to attain improved security.

According to the present invention, it is possible to achieve a security system and security apparatus which are provided with functions that can efficiently transfer requirements of visitors who are anticipated by users.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

What is claimed is:

1. A security apparatus comprising:
means for acquiring a phone number of a cellular phone carried by a visitor;
a memory which stores at least one phone number of cellular phone;
transfer judgment means for comparing said phone number acquired by said acquisition means with said phone number stored in said memory, and judges whether or not to execute a transfer to a PDA unit to be redirected based on a comparison result; and
notifying means for, based on the judgment result of said transfer judgment means, notifying the PDA unit to be redirected of one's visit.

2. A security apparatus comprising:
a receiver which receives a phone number of a cellular phone carried by a visitor;
a memory which stores at least one phone number of cellular phone;
a transfer unit which compares said phone number received by said receiver with said phone number stored in said memory to determine, and transfers a PDA unit to be redirected of a visiting of the visitor based on a comparison.

3. A security apparatus according to claim 1, wherein said acquisition means receives said phone number that is periodically transmitted by said cellular phone of the visitor to a base station to acquire said phone number.

4. A security apparatus according to claim 2, wherein said receiver receives said phone number that is periodically transmitted by said cellular phone of the visitor to a base station.

5. A security apparatus according to claim 2 further comprising:
a camera unit which takes a picture for the visitor to produce image signals thereof; and
a microphone unit which produces audio signals based on voices of the visitor;
wherein said transfer unit transfers said image signals produced by said camera unit and said audio signals produced by said microphone unit to the PDA unit to be redirected.

6. A security apparatus according to claim 1, wherein said transfer judgment means transmits said phone number of the visitor to a security company server when said phone number of the visitor does not correspond to said phone number stored in said memory, and said notifying means, based on the retrieval results of said security company server, notifies the PDA unit to be redirected of said visiting of the visitor of one's visit.

7. A security apparatus according to claim 2, wherein said transfer unit transmits said phone number of the visitor to a security company server when said phone number of the visitor does not correspond to said phone number stored in said memory, and, based on the retrieval results of said security company server, notifies the PDA unit to be redirected of said visiting of the visitor.

8. A security apparatus according to claim 2, wherein said memory stores a phone number of an anticipated visitor that is transmitted from a security company server.

9. A security apparatus according to claim 2, further comprising a reception function unit for receiving authorized data of reception signature issuance for the visitor or reception signature from the PDA unit to be redirected, and issuing reception signature based on said authorized data of reception signature issuance or reception signature.

10. A security apparatus according to claim 9, wherein said reception function unit transmits said reception signature to the security company server or said cellular phone carried by the visitor.

11. A security apparatus according to claim 2, further comprising a recording unit for, at the time of issuing said reception signature, taking an image for the visitor and recording images.

12. A security apparatus according to claim 2, further comprising a sensor which detects a package, said package being delivered by the visitor, or a camera unit which takes a picture for the package for surveillance of the package.

13. A security apparatus comprising:
a security apparatus for acquiring a phone number of a cellular phone of a visitor, and transmitting the phone number of the visitor to a security company server; and
a security company server including a memory for storing a phone number of an anticipated visitor, and a transfer judgment unit which compares a phone number of a visitor transmitted from said security apparatus with phone numbers stored in said memory to determine, and judges whether or not to execute the transfer to a PDA unit to redirected based on such comparison result;
wherein said security apparatus or said security company server notifies the PDA unit to be redirected of visiting of the visitor based on the judgment result of said security company server.

14. A security apparatus according to claim 13, wherein said security apparatus is provided with security apparatus memory which stores at least one phone number, compares said phone number of the visitor that is acquired with said phone numbers stored in advance in said security apparatus memory, and transmits said phone number of the visitor to the security company server when said phone number of the visitor does not correspond to said phone number stored in said memory.

15 A security apparatus according to claim 13, wherein said security apparatus receives said phone number that is periodically transmitted by said cellular phone of the visitor to a base station.

16. A server capable of communicating with a security apparatus which acquires a phone number of a cellular phone of the visitor and transmits said phone number of the visitor to a security company server comprising:
a memory which stores a phone number of an anticipated visitor; and
a transfer judgment unit which compares said phone number of the visitor transmitted from said security apparatus with said phone numbers stored in said memory to determine, and judges whether or not to execute the transfer to a PDA unit to be redirected based on a comparison.
